(19) United States
(12) Patent Application Publication
(10) Pub. No.: US 2021/0387461 A1
(43) Pub. Date: Dec. 16, 2021

(54) PRINTER DEVICE CAPABLE OF ADJUSTING PAPER

(71) Applicant: KINPO ELECTRONICS, INC., New Taipei City (TW)

(72) Inventors: Tzu-Cheng CHANG, New Taipei City (TW); Hung-Huan SUNG, New Taipei City (TW)

(21) Appl. No.: 16/930,189

(22) Filed: Jul. 15, 2020

(30) Foreign Application Priority Data
Jun. 16, 2020 (CN) 202010546326.X

(51) Int. Cl. B41J 11/00; B41J 11/48; B41J 13/02; B41J 13/14; B41J 15/04

(52) U.S. Cl. CPC B41J 11/005; B41J 11/48; B65H 29/70; B41J 13/14; B41J 15/042; B41J 13/025

(57) ABSTRACT

The disclosure is directed to a printer device including a printer body, a paper correction module, and a processor. The printer body has a media feed path. The printer body detects a width of the paper to output a paper size signal. The paper correction module is installed in the media feed path. The paper correction module includes two paper guiding arms and an actuating mechanism. The actuating mechanism is capable of driving the two paper guiding arms to approach or move away from each other. The processor is electrically connected with the actuating mechanism. After the processor receives the paper size signal, the actuating mechanism is controlled to space the two paper guiding arms with a preset interval.

### BACKGROUND OF THE INVENTION

### Field of the Invention

The technical field relates to a printer device, and more particularly, to a printer device capable of adjusting paper.

### Description of Related Art

Offices usually have printers with functions such as printing, copying or scanning etc. By feeding paper from an external manual tray or an internal paper tray, employees can perform printing, copying, or scanning from their word processor, and ensure that the paper will be output through the output tray.

However, when the above-mentioned printer is in use, papers are likely to be skewed or offset during the feeding process, which leads to skewed images in printing, copying or scanning, or paper jams occurring. Therefore, a goal of the industry is to figure out how to avoid paper skew or offsets, so as to achieve the highest quality images in printing, copying or scanning for improving the printer.

In view of the above drawbacks, the inventor proposes the present invention based on his expert knowledge and elaborate research in order to solve the problems of prior art.

### SUMMARY OF THE INVENTION

The disclosure is directed to provide a printer device capable of adjusting paper, in which the paper is fed to be restricted between two paper guiding arms, so that the printer device has the effect of correcting the paper orientation.

The disclosure is directed to provide a printer device capable of adjusting paper, which is applied for correcting the orientation of a paper. The printer device includes a printer body with an input tray and a media feed path. The paper is fed from the paper tray to the media feed path, and when the paper is in the paper tray, the printer body detects a width of the paper to output a paper size signal. A paper correction module is installed in the media feed path, and the paper correction module includes two paper guiding arms and an actuating mechanism connected with the two paper guiding arms. The two paper guiding arms are disposed at the left and right sides of the media feed path, and the actuating mechanism is capable of driving the two paper guiding arms to approach or move away from each other. A processor is electrically connected with the actuating mechanism. After the processor receives the paper size signal, the actuating mechanism is controlled to space the two paper guiding arms at a preset interval, so that the paper can be placed in the preset interval and restricted between the two paper guiding arms.

In one of the exemplary embodiments, during the process of feeding the paper in the media feed path continuously, the paper is guided to the correct position by the two paper guiding arms to avoid the paper being skewed or offset, so that the printer device has the advantages of determining paper sizes automatically, correcting the paper position, being made of simple structures, and improving the quality of printing, copying or scanning.

In one of the exemplary embodiments, when the paper is placed in the paper tray, the processor receives the paper size signal and the distance of the two paper guiding arms is quickly controlled to the preset interval before the paper enters the media feed path; therefore, the process of correcting the paper has the advantages of not affecting the speed of printing, copying or scanning, and the printer device has the characteristics of supporting high-speed printing, copying or scanning.

### BRIEF DESCRIPTION OF DRAWINGS

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of the printer device of the present disclosed example.

FIG. 2 is another perspective schematic view of the printer device of the present disclosed example.

FIG. 3 is an operation schematic view of the paper tray and the distance sensor of the present disclosed example.

FIG. 4 is a perspective explosion view of the paper correction module of the present disclosed example.

FIG. 5 is a perspective assembly view of the paper correction module of the present disclosed example.

FIG. 6 is an operation schematic view of the paper correction module of the present disclosed example.

FIG. 7 is an operation schematic view of the printer device of the present disclosed example.

FIG. 8 is an operation schematic view of another embodiment of the printer device of the present disclosed example.

FIG. 9 is an operation schematic view of a further embodiment printer device of the present disclosed example.

FIG. 10 is an operation schematic view of another embodiment of the paper tray and the distance sensor of the present disclosed example.

### DETAILED DESCRIPTION OF THE PREFERRED EMBODIMENTS

In cooperation with attached drawings, the technical contents and detailed description of the invention are described thereinafter according to a number of preferable embodiments, not being used to limit its executing scope. Any equivalent variation or modification made according to appended claims is covered by the claims claimed by the present invention.

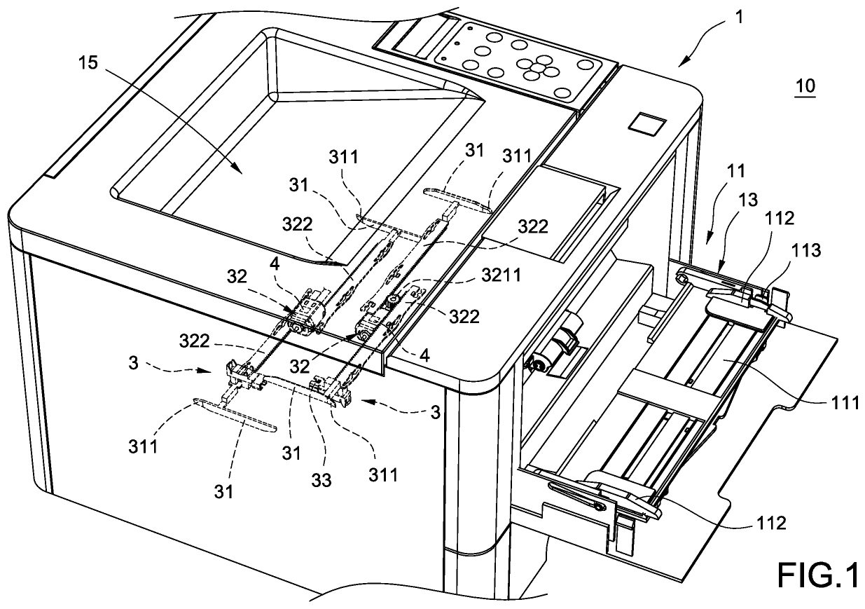

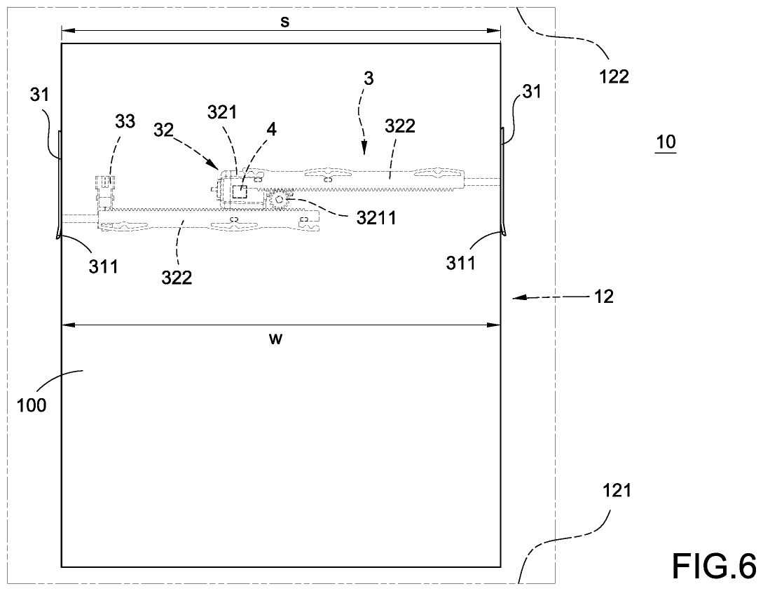

Please refer to FIG. 1 to FIG. 7. The present disclosed example provides a printer device capable of adjusting paper, which is applied to correct the orientation of a paper 100. The printer device 10 mainly includes a printer body 1, a paper correction module 3, and a processor 4.

As shown in FIG. 1 to FIG. 3 and FIG. 6 to FIG. 7, the printer body 1 has an input tray 11 and a media feed path 12. The front and rear sides of the media feed path 12 have a paper feed end 121 and a paper output end 122. The paper 100 is fed from the paper tray 11 to the media feed path 12, and the paper 100 is then transported from the paper feed end 121 to the paper output end 122.

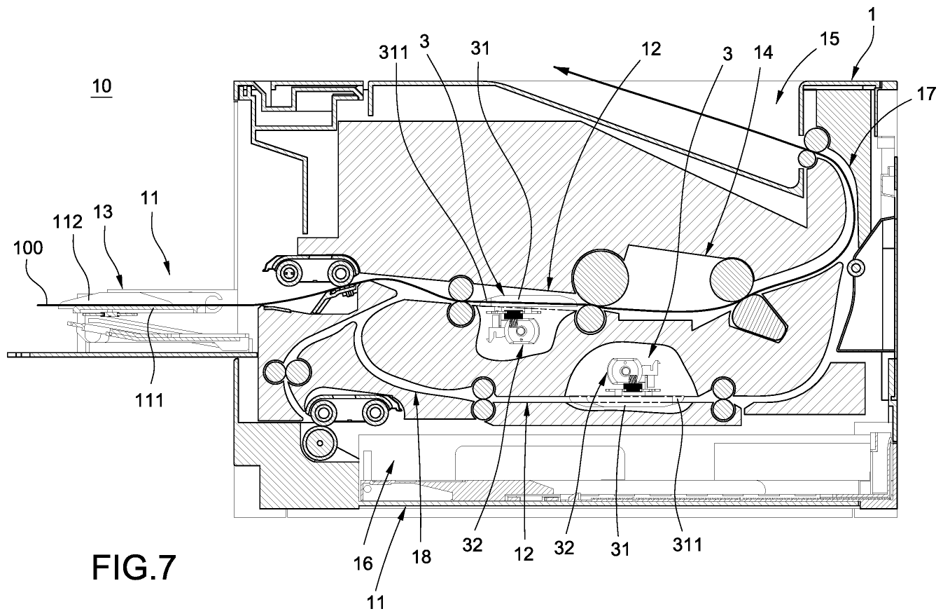

A more detailed description is as follows. As shown in FIG. 7, the paper tray 11 of the present embodiment is an external manual tray 13 installed outside the printer body 1. The printer body 1 further has a working area 14 and a paper output tray 15. The media feed path 12 is arranged at the front end of the working area 14 and between the external manual tray 13 and the working area 14. The paper 100 is fed sequentially starting from the external manual tray 13, to the media feed path 12, to the working area 14, and finally to the paper output tray 15, wherein a printing unit or a scanning unit is installed in the working area 14 to print or scan the paper 100 as to complete a one-sided printing or scanning of the paper 100.

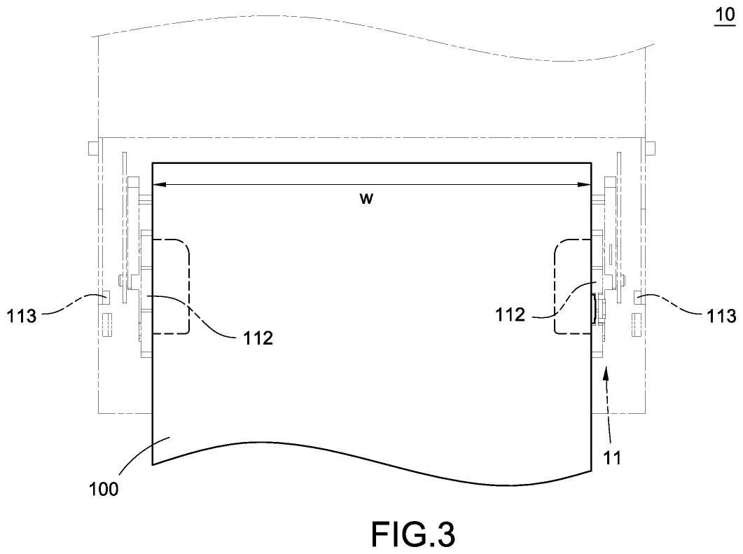

In addition, as shown in FIG. 3, when the paper 100 is in the paper tray 11, the printer body 1 can detect a width w of the paper 100 to output a paper size signal.

The manner of detecting the width W of the paper 100 in the printer body 1 of the present embodiment is as follows. The paper tray 11 has a chassis 111, two width movable clips 112 installed and is movable on the chassis 11, and two distance sensors 113 disposed corresponding to the two width movable clips 112. When users place the paper 100 in the chassis 111, the two width movable clips 112 are moved simultaneously, so that the two width movable clips 112 are attached to the left and right sides of the paper 100. After, the two distance sensors 113 sense the distance between the two width movable clips 112, detecting the width W of the paper 100 as the paper size signal to output.

Wherein, the distance sensor is a laser sensor or an ultrasonic sensor. The light which the laser sensor emits is invisible to humans and has the advantages of a fast response and not being affected by suspended matter (dust) in the air. The light which the ultrasonic sensor emits is invisible to humans and is not affected by ambient light or suspended matter (dust) in the air.

Furthermore, after the two width movable clips 112 are attached to the left and right sides of the paper 100, the computing system inside the printer body 1 can also calculate the width W of the paper 100 from the position of the two width movable clips 112 to output the paper size signal, or users can input the paper size by themselves through the printer body 1 to output the paper size signal. Therefore, the manner of detecting the width W of the paper 100 of the printer body 1 is not limited to the present embodiment.

As shown in FIG. 1 to FIG. 2 and FIG. 4 to FIG. 7, the paper correction module 3 is installed in the media feed path 12. The paper correction module 3 includes two paper guiding arms 31 and an actuating mechanism 32 connected with the two paper guiding arms 31. The two paper guiding arms 31 are disposed at the left and right sides of the media feed path 12. The actuating mechanism 32 is capable of driving the two paper guiding arms 31 to approach or move away from each other. Wherein, the two paper guiding arms 31 extends two inclined guides 311 with an interval distance gradually increased in a direction toward the paper feed end 121.

Moreover, the actuating mechanism 32 includes a motor 321 and two transverse racks 322. The motor 321 has a driving gear 3211, and the two transverse racks 322 are arranged at two sides of the driving gear 3211 and mesh with the driving gear 3211. The two paper guiding arms 31 are extended from one end of the two transverse racks 322 away from the driving gear 3211. The motor 321 is electrically connected with the processor 4.

Furthermore, the two transverse racks 322 of the present embodiment are arranged symmetrically with the driving rack 3211 at the center; thus, the movement of the two transverse racks 322 meshing with the driving gear 3211 is the same, so that the movement of the two paper guiding arms 31 to approach or move away from each other is also the same.

In addition, the actuating mechanism 32 further includes an original point sensor 33, and the original point sensor 33 is fixed at one of the transverse racks 322. The original point sensor 33 is provided to sense the return to an original point to output a return signal.

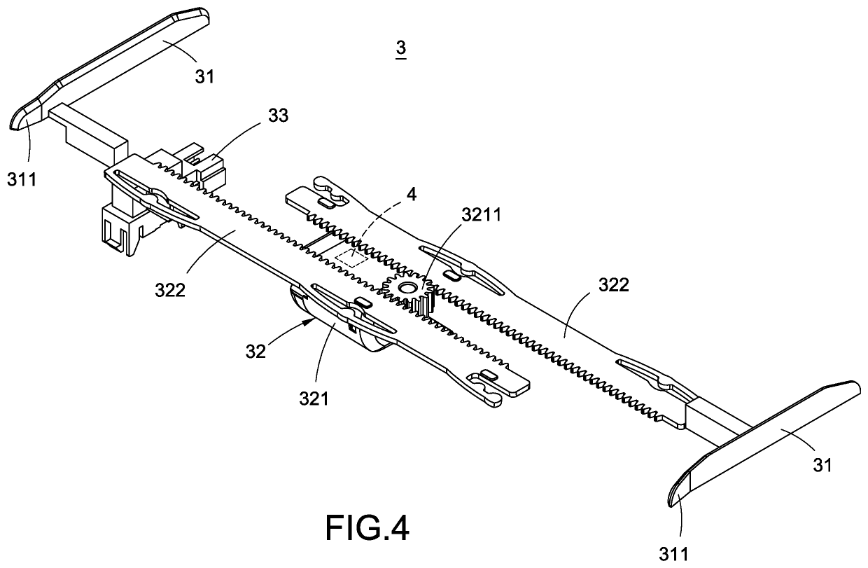

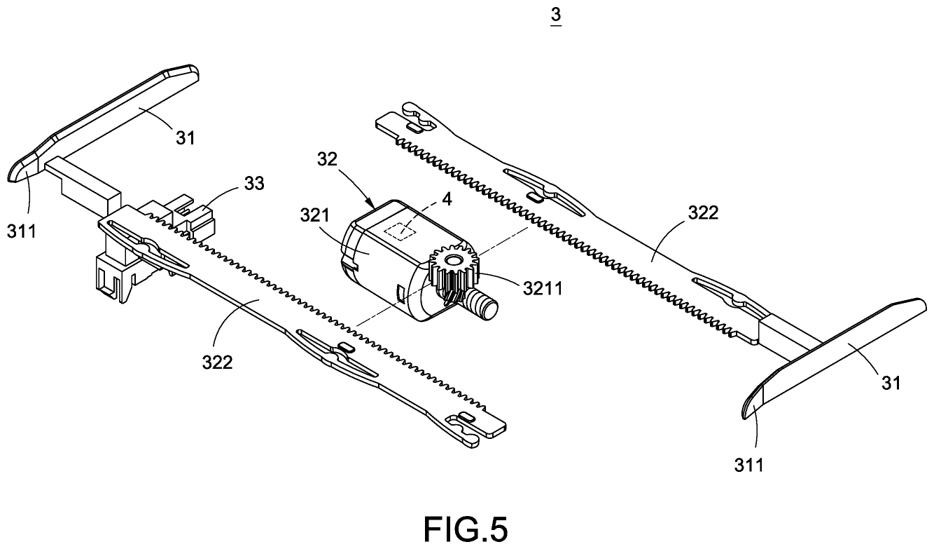

As shown in FIG. 4 to FIG. 5, the processor 4 is electrically connected with the distance sensors 113 and the actuating mechanism 32 separately. After the processor 4 receives the paper size signal, the actuating mechanism 32 is controlled to space the two paper guiding arms 31 with a preset interval S, so that the paper 100 can be placed in the preset interval S and restricted between the two paper guiding arms 31. Wherein, the preset interval S is a width W of the paper 100 times 1.01 to 1.015. Further explanation is as follows. After the processor 4 receives the paper size signal, the actuating mechanism 32 is first controlled to drive the original point sensor 33 to return to the original point. After the processor 4 receives the return signal, the actuating mechanism 32 is then controlled to drive the two paper guiding arms 32 to be retracted to the preset distance S.

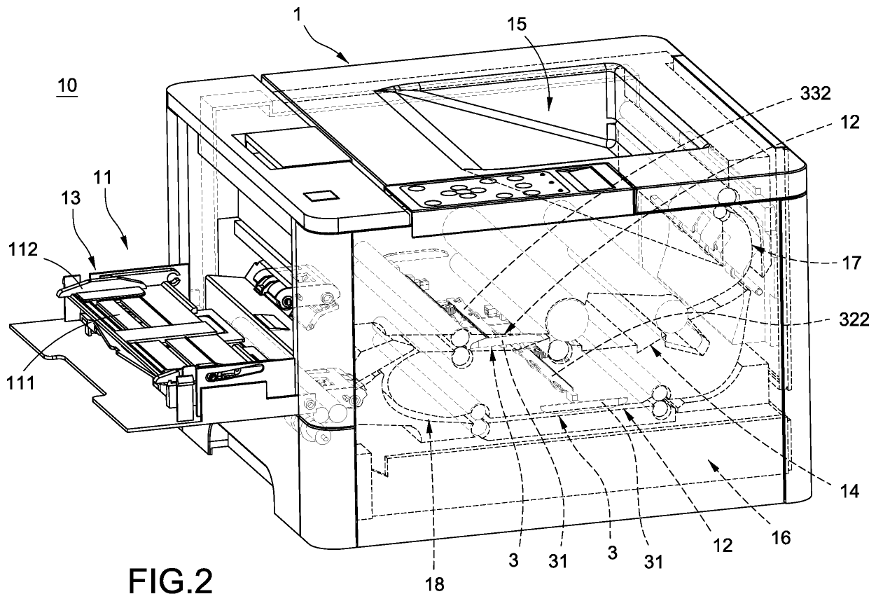

As shown in FIG. 2 to FIG. 3 and FIG. 6 to FIG. 7, operation schematic views of the present disclosed example are depicted. First, users place the paper 100 in the paper tray 11 between the two width movable clips 112 so the distance sensors 113 can detect the width W of the paper 100 through the adjustment of the two width movable clips 112 to output the paper size signal.

Then, after the processor 4 receives the paper size signal, the motor 321 drives the driving gear 3211 to rotate, meshing with the two transverse racks 322 and moved outwardly until the original point sensor 33 returns to the original point to output the return signal; then the processor 4 receives the return signal to control the driving gear 3211, meshing with the two transverse racks 322 and moved inwardly until the two paper guiding arms 31 retract to the preset interval S. Therefore, the two paper guiding arms 31 is spaced with the preset interval S before the paper 100 enters the media feed path 12.

Finally, the paper 100 is fed from the paper tray 11 to the media feed path 12. When the paper 100 enters the media feed path 12 from the paper feed end 121, the two inclined guides 311 are disposed at the left and right sides of the paper 100 to guide the paper 100 to gradually enter between the two paper guiding arms 31. The two paper guiding arms 31 have a spaced distance close to the width W of the paper 100 and are attached to the left and right sides of the paper 100. Thus, in the process of continuous feeding in media feed path 12, the paper 100 is guided to the correct position by the two paper guiding arms 31, preventing the paper 100 from being skewed or offset, etc., so that the printer device 10 has the advantages of determining the paper 100 sizes automatically, correcting the paper 100 position, being made of simple structures, improving quality of printing, copying or scanning.

Furthermore, the preset interval S is a width of paper times 1.01 to 1.015. For example, if the width W of the paper 100 is 210 mm, then the preset interval S is 212.1 (210×1.01) mm to 213.15 (210×1.015) mm. Therefore, the two paper guiding arms 31 can accurately guide the position of the paper 100, and the paper 100 can also be prevented from being over clamped; thereby, the service life of the printer device 10 can be improved.

Moreover, when the paper 100 is placed in the paper tray 11, after the processor 4 receives the paper size signal, the spaced distance between the two paper guiding arms 31 is quickly controlled to the preset interval S before the paper 100 enters the media feed path 12 without affecting the speed of printing, copying or scanning during the process of correcting the paper 100 orientation, and the two inclined guides 311 can guide the paper 100 to gradually enter between the two paper guiding arms 31 to avoid the paper 100 from scratching on impact. Hence, the printer device 10 can support high-speed printing, copying or scanning.

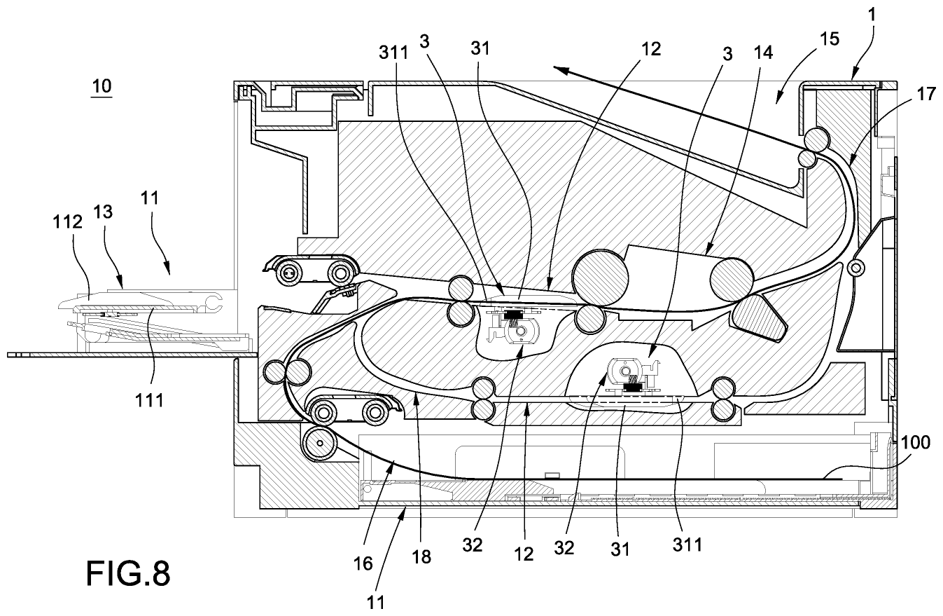

Please refer to FIG. 8, it depicts another embodiment of the printer device 10 of the present disclosed example. The embodiment of FIG. 8 is substantially the same as the embodiment of FIG. 1 to FIG. 7. The embodiment of FIG. 8 differs from the embodiment of FIG. 1 to FIG. 7 in that the structure and position of the paper tray 11 are different.

A further explanation is as follows. The paper tray 11 of the present embodiment is an internal paper tray 16 installed inside the printer body 1. The media feed path 12 is arranged at the front end of the working area 14 and between the internal paper tray 16 and the working area 14. The paper 100 is sequentially fed first from the internal paper tray 16, to the media feed path 12, to the working area 14 and finally to the paper output tray 15, wherein a printing unit or a scanning unit is installed in the working area 14 to print or scan a paper 100, so as to complete one-sided printing or scanning of paper 100. Therefore, the paper 100 will be guided by the two paper guiding arms 31 before entering the working area 14, so as to achieve the same functions and effects of the embodiment shown in FIG. 1 to FIG. 7.

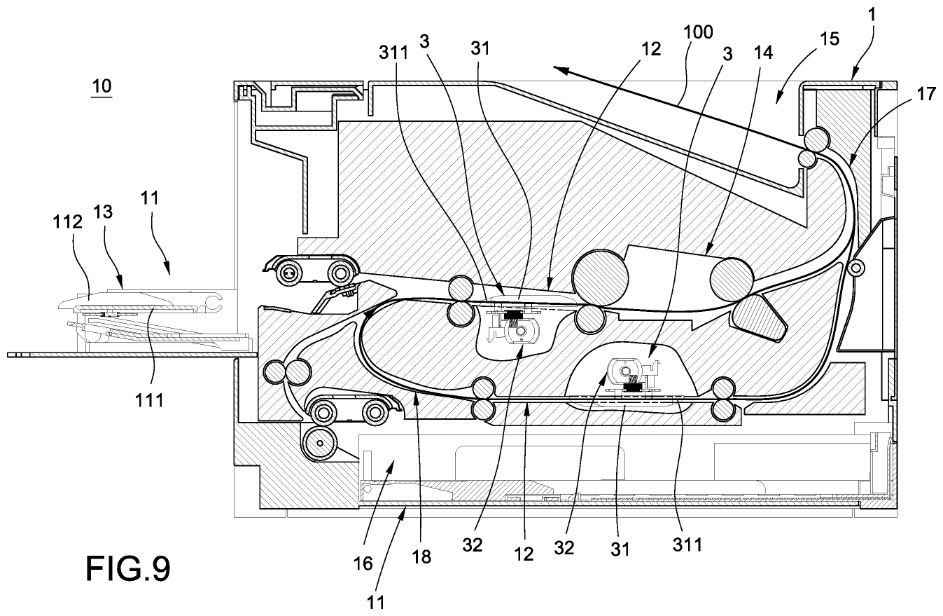

Please refer to FIG. 9, which depicts a further embodiment of the printer device of the present disclosed example. The embodiment of FIG. 9 is substantially the same as the embodiments of FIG. 1 to FIG. 7 and FIG. 8. The embodiment of FIG. 9 differs from the embodiment of FIG. 1 to FIG. 7 and FIG. 8 in that the quantity of media feed path 12 and paper correction modules 3 can be plural.

The detailed description is as follows. The printer body 1 further has a rewinding path 17 communicated with the paper output tray 15 and a turning path 18 communicated with the working area 14. The rewinding path 17 is provided for rewinding a one-sided printed or scanned paper 100 from the paper output tray 15 to the turning path 18. The turning path 18 is provided for turning the one-sided printed or scanned paper 100 and transporting the paper 1000 to the working area 14 for printing or scanning the other side of the paper 100.

Furthermore, the quantity of the media feed path 12 and paper correction modules 3 in the present embodiment is two. Each of the paper correction modules 3 is installed in the media feed path 12. One media feed path 12 is disposed at the front end of the working area 14 and between the working area 14 and the turning path 18; another media feed path 12 is disposed at the front end of the turning path 18 and between the rewinding path 17 and the turning path 18.

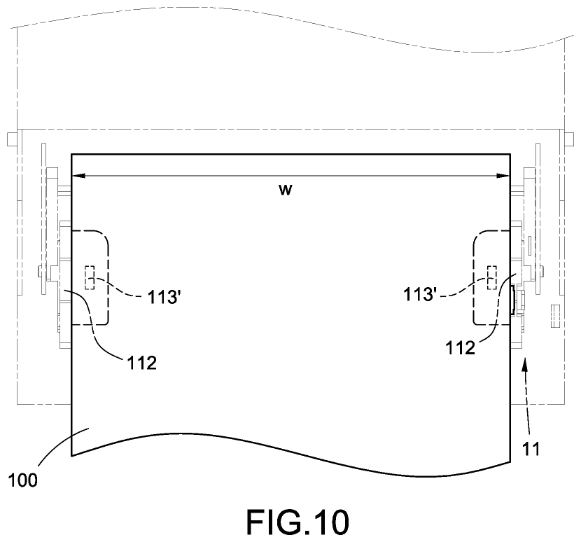

After that, as shown in FIG. 1 to FIG. 7 and FIG. 8, the paper 100 is fed sequentially from the input tray 11 (external manual tray 13 or internal paper tray 16), to the media feed path 12, to the working area 14, and finally to the paper output tray 15, wherein the printing unit or the scanning unit in the working area 14 can print or scan one side of the paper 100 to complete one-sided printing or scanning of the paper 100. As shown in FIG. 9, the paper 100 is feed sequentially from first the paper output tray 15, to the rewinding path 17, to the media feed path 12, to the turning path 18, to the working area 14, and finally to paper output tray 15, wherein the printing unit or the scanning unit in the working area 14 can print or scan the other side of the paper 100 to complete double-sided printing or scanning of the paper 100. Thereby, the paper 100 will be guided by the two paper guiding arms 31 before entering the working area 14 and the turning path 18, so as to achieve the same functions and effects of the embodiment of FIG. 1 to FIG. 7. Please refer to FIG. 10, which is another embodiment of the paper tray 11 and the distance sensor 113′ of the present disclosed example. The embodiment of FIG. 10 is substantially the same as the embodiment of FIG. 1 to FIG. 7. The embodiment of FIG. 10 differs from the embodiment of FIG. 1 to FIG. 7 in that the distance sensor 113′ has a different method of detecting the width W of the paper 100.

A more detailed description is as follows. The two distance sensors 113′ of the present embodiment are fixed at the two width movable clips 112. When users place the paper 100 in the chassis 111, the two width movable clips 112 will be moved at the same time, so that the two width movable clips 112 are attached to the left and right sides of the paper 100. Then, the distance sensor 113′ senses the distance moved of the two width movable clips 112 to know the width W of the paper 100 to output the paper size signal. Therefore, the same functions and effects of the embodiment of FIG. 1 to FIG. 7 can be achieved.

Wherein, the distance sensors 113′ is an optical scale sensor, and the optical scale sensor has advantages of having high precision, being hard to be interfere, and having a fast detection speed. In summary, the present invention fully meets the requirements of a patent to file the application in accordance with Patent Law. Please research and grant the present invention registration to protect the rights of the inventor.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A printer device capable of adjusting paper, which is applied for correcting a paper, the printer device comprising:
a printer body having an input tray and a media feed path, wherein the paper is fed from the paper tray to the media feed path, and when the paper is in the paper tray, the printer body detects a width of the paper to output a paper size signal;
a paper correction module installed in the media feed path, and the paper correction module including two paper guiding arms and an actuating mechanism connected with the two paper guiding arms; and the two paper guiding arms being disposed at left and right sides of the media feed path, and the actuating mechanism being capable of driving the two paper guiding arms to approach or move away from each other; and
a processor electrically connected with the actuating mechanism; wherein, after the processor receives the paper size signal, the actuating mechanism is controlled to space the two paper guiding arms with a preset interval, so that the paper can be placed in the preset interval and restricted between the two paper guiding arms.

2. The printer device capable of adjusting paper according to claim 1, wherein the preset interval is a width of paper times 1.01 to 1.015.

3. The printer device capable of adjusting paper according to claim 1, wherein the media feed path has a paper feed end, and the two paper guiding arms extend two inclined guides having an interval distance gradually increased in a direction toward the paper feed end.

4. The printer device capable of adjusting paper according to claim 1, wherein the actuating mechanism includes a motor and two transverse racks; the motor has a driving gear, and the two transverse racks are arranged at two sides of the driving gear and mesh with the driving gear; the two paper guiding arms extend from one end of the two transverse racks away from the driving gear; and the motor is electrically connected with the processor.

5. The printer device capable of adjusting paper according to claim 4, wherein the actuating mechanism further includes an original point sensor, and the original point sensor is fixed at one of the transverse racks; and the original point sensor is provided for sensing a return to an original point to output a return signal.

6. The printer device capable of adjusting paper according to claim 5, wherein after the processor receives the paper size signal, the actuating mechanism is controlled to drive the original point sensor to return to the original point; and when the processor receives the return signal, the actuating mechanism is controlled to space the two paper guiding arms with the preset interval.

7. The printer device capable of adjusting paper according to claim 1, wherein the paper tray has a chassis, two width movable clips installed and is movable on the chassis, and two distance sensors disposed corresponding to the two width movable clips; and the two distance sensors are provided to sense a distance between the width movable clips to output the paper size signal.

8. The printer device capable of adjusting paper according to claim 7, wherein each of the distance sensors is a laser sensor or an ultrasonic sensor.

9. The printer device capable of adjusting paper according to claim 1, wherein the paper tray has a chassis, two width movable clips installed and is movable on the chassis, and two distance sensors are fixed at the two width movable clips; and the two distance sensors are provided for sensing a moving distance of the two width movable clips to output the paper size signal.

10. The printer device capable of adjusting paper according to claim 9, wherein each of the distance sensors is an optical scale sensor.

11. The printer device capable of adjusting paper according to claim 1, wherein the paper tray is an external manual tray installed outside the printer body; and the printer body further has a working area, and the media feed path is disposed between the external manual tray and the working area.

12. The printer device capable of adjusting paper according to claim 1, wherein the paper tray is an internal paper tray installed inside the printer body; and the printer body further has a working area, and the media feed path is disposed between the internal paper tray and the working area.

13. The printer device capable of adjusting paper according to claim 1, wherein the printer body further has a working area, and the media feed path is arranged at a front end of the working area.

14. The printer device capable of adjusting paper according to claim 1, wherein the printer body further has a rewinding path and a turning path, and the media feed path is arranged between the rewinding path and the turning path.

15. The printer device capable of adjusting paper according to claim 1, wherein the printer body further has a turning path, and the media feed path is arranged at a front end of the turning path.
